(19) United States
(12) Patent Application Publication
(10) Pub. No.: US 2014/0340518 A1
(43) Pub. Date: Nov. 20, 2014

(54) EXTERNAL SENSING DEVICE FOR VEHICLE, METHOD OF CORRECTING AXIAL DEVIATION AND RECORDING MEDIUM

(71) Applicant: Nidec Elesys Corporation, Yokohama-Shi (JP)

(72) Inventors: Takeshi KAMBE, YOKOHAMA-SHI (JP); Kazuyuki SEKINE, TOKYO (JP); Akira MITSUTA, ODAWARA-SHI (JP)

(73) Assignee: Nidec Elesys Corporation, Yokohama-Shi (JP)

(21) Appl. No.: 14/279,791

(22) Filed: May 16, 2014

(30) Foreign Application Priority Data
May 20, 2013 (JP) 2013-106290

(51) Int. Cl. G06K 9/00; B60R 1/00

(52) U.S. Cl. CPC G06K 9/00791; B60R 1/00; G06K 9/00805; G06K 9/00798
USPC 348/148

(57) ABSTRACT

A driving support device has a lane marking recognition unit that recognizes at least two lane markings based on a taken image; a deviation angle calculation unit that calculates a deviation angle based on at least the two lane markings; an obstacle recognition unit that recognizes an obstacle position based on the taken image; a camera deviation angle correction unit that corrects the obstacle position recognized by the obstacle recognition unit by the deviation angle; a radar deviation angle correction unit that corrects the obstacle position detected by a radar by the deviation angle; and a driving support processing unit that executes a driving support process based on the corrected obstacle positions.

### CROSS REFERENCE TO RELATED APPLICATION

The present application claims benefit of the filing date of Japanese Patent Application No. 2013-106290 filed on May 20, 2013, the disclosure of which is incorporated herein by reference.

### BACKGROUND OF THE INVENTION

1. Field of the Invention

The invention relates to an external sensing device for a vehicle which corrects a deviation angle between an axial direction of an onboard camera and an obstacle detection sensor having the same axis to be mounted in a vehicle and a traveling direction of a vehicle, a method of correcting axis deviation thereof and a non-transitory computer readable recording medium recorded with an executable program for correcting the deviation angle.

2. Description of the Related Arts

Recently, a vehicle control system such as a following distance warning system, a preceding vehicle following control system, collision avoidance/reduction brake system is becoming widespread. In the vehicle control system, an external sensing device for a vehicle is used for detecting an object which could be an obstacle. The external sensing device for a vehicle has an obstacle detection sensor such as an onboard camera, a millimeter wave radar and a laser radar.

When the external sensing device for a vehicle has a radar having low mounting precision and a radar reference axis deviates with respect to a traveling direction (the front) of a vehicle, the obstacle cannot be detected correctly. Adjusting the radar reference axis to the traveling direction of the vehicle based on the object (for example, a pole beside a road) detected by the radar has been proposed in JP4665903B.

### SUMMARY OF THE INVENTION

In the related art disclosed above, a problem in which axis deviation of the radar reference axis cannot be corrected properly remains as explained below.

As illustrated in FIG. 7, when a vehicle 90 is moving straight, the radar detects an object A such that the object A comes close to the vehicle 90 in an opposite direction of the traveling direction of the vehicle 90 (arrow in solid line). On the other hand, when the radar reference axis is deviated, the radar often detects the object A such that the object A comes close to the vehicle 90 from an oblique direction (arrow in broken line). However, the object detected by the radar often includes an error in a lateral direction due to ambient environment or a shape of the target obstacle (arrow in long and short dashed line). Therefore, the related art described above cannot calculate a deviation angle of the radar reference axis correctly and cannot correct the axis deviation precisely.

The invention has been developed to solve the above-described problem, and an object of the invention is to provide an external sensing device for a vehicle which corrects a deviation angle precisely, a method of correcting axis deviation thereof and a non-transitory computer readable recording medium recorded with an executable program for correcting the deviation angle.

In view of the above-described problems, an external sensing device for a vehicle of a first invention that corrects a deviation angle between an axial direction of an onboard camera and an obstacle detection sensor mounted in a vehicle to have a same axis and a traveling direction of the vehicle has: a lane marking recognition unit that recognizes at least two lane markings painted on a road based on a taken image in which the traveling direction of the vehicle is taken by the onboard camera; a deviation angle calculation unit that decides whether the vehicle is moving straight, and calculates the deviation angle based on at least the two lane markings recognized by the lane marking recognition unit when the vehicle is moving straight; and a deviation angle correction unit that corrects an obstacle position recognized based on the taken image and an obstacle position detected by the obstacle detection sensor by the deviation angle calculated by the deviation angle calculation unit.

In the external sensing device for a vehicle of a second invention, the onboard camera and the obstacle detection sensor are accommodated in one casing and are adjusted so that an optical axis direction of the onboard camera and an irradiation direction of the obstacle detection sensor have a same axis.

In the external sensing device for a vehicle of a third invention, the deviation angle calculation unit determines a positional deviation amount between a vanishing point that is determined based on at least the two lane markings recognized by the lane marking recognition unit and a center of the taken image, and calculates the deviation angle based on the positional deviation amount.

In the external sensing device for a vehicle of a fourth invention, the deviation angle correction unit decides whether the deviation angle calculated by the deviation angle calculation unit is equal to or more than a predetermined threshold value and corrects the obstacle position when the deviation angle is equal to or more than the threshold value.

In the external sensing device for a vehicle of a fifth invention, the deviation angle calculation unit does not calculate the deviation angle in case that the lane marking recognition unit cannot recognize the lane markings or in case that the vehicle is not moving straight.

The external sensing device for a vehicle of a sixth invention further has a driving support processing unit that executes a driving support process for the vehicle based on the obstacle position corrected by the deviation angle correction unit.

In view of the above-mentioned problems, a recording medium of a seventh invention is a non-transitory computer readable medium with an executable program stored thereon that makes a computer function as the external sensing device for a vehicle according to the first invention.

In view of the above-mentioned problems, a method of correcting axial deviation of an eighth invention having a lane marking recognition unit, a deviation angle calculation unit and a deviation angle correction unit that corrects a deviation angle between an axial direction of an onboard camera and an obstacle detection sensor mounted in a vehicle to have a same axis and a traveling direction of the vehicle, includes: recognizing by the lane marking recognition unit at least two lane markings painted on a road based on a taken image in which the traveling direction of the vehicle is taken by the onboard camera; deciding whether the vehicle is moving straight, and calculating the deviation angle by the deviation angle calculation unit based on at least the two lane markings recognized by the lane marking recognition unit when the vehicle is moving straight; and correcting by the deviation angle correction unit an obstacle position recognized based on the taken image and an obstacle position detected by the obstacle detection sensor by the deviation angle calculated in the deviation angle calculation.

### BRIEF DESCRIPTION OF THE DRAWINGS

FIG. 1 is an explanatory view for explaining an example of an external sensing device for a vehicle in an embodiment of the invention;

FIG. 2A is an explanatory view for explaining axial deviation of the onboard camera and the radar in FIG. 1 in a state without the axial deviation, and FIG. 2B is an explanatory view for explaining axial deviation of the onboard camera and the radar in FIG. 1 in a state with the axial deviation;

FIG. 3 is a block diagram illustrating a structure of a driving support device according to the embodiment of the invention;

FIG. 4A is an explanatory view of a taken image without the axial deviation for explaining a specific example of a deviation angle calculation process in a deviation angle calculation unit in FIG. 1, and FIG. 4B is an explanatory view of a taken image with the axial deviation for explaining a specific example of the deviation angle calculation process in the deviation angle calculation unit in FIG. 1;

FIG. 5 is a flowchart illustrating an operation of the driving support device in FIG. 3;

FIG. 6 is a flowchart illustrating a deviation angle correction process in FIG. 5; and

FIG. 7 is an explanatory view for explaining a problem in the related art.

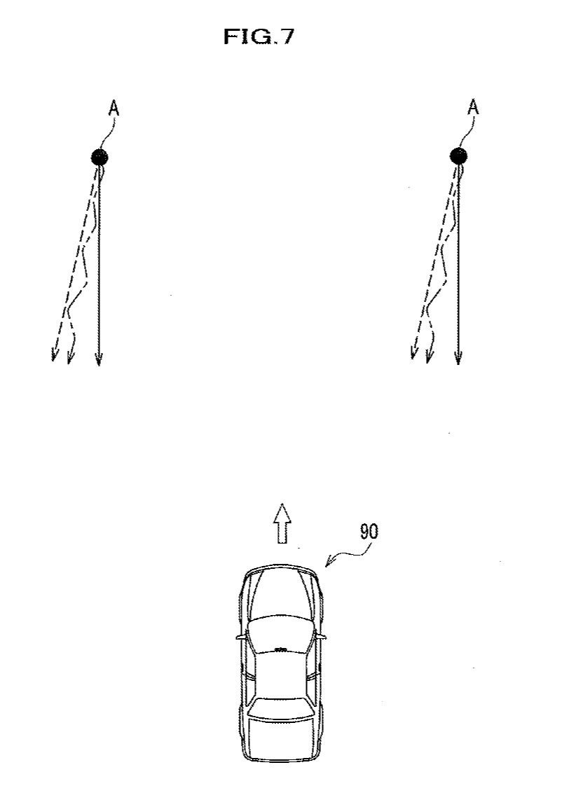

### DETAILED DESCRIPTION OF THE PREFERRED EMBODIMENTS

### Embodiment

A preferred embodiment of the invention will be explained in detail with reference to accompanying drawings as necessary. In the embodiment and each alternative, a unit having the same function is labeled with the same number and explanation thereof will be omitted.

### External Sensing Device for a Vehicle

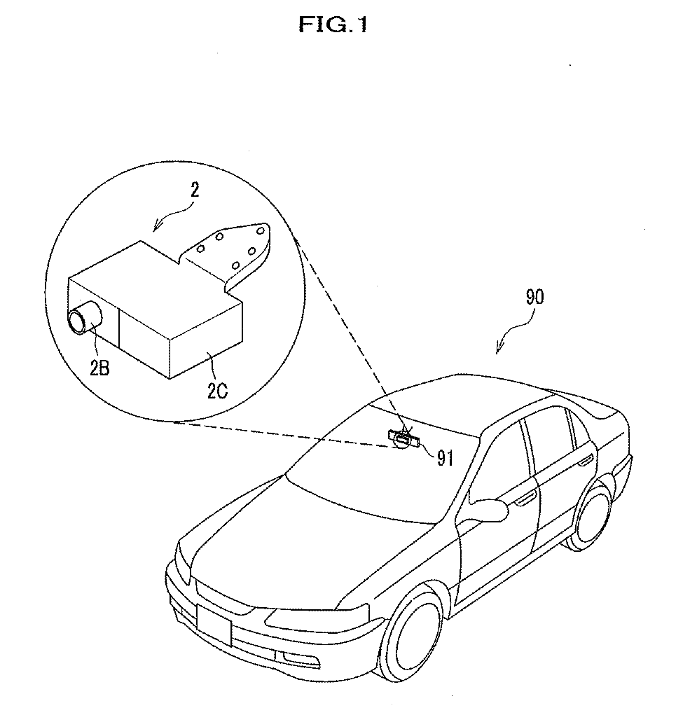

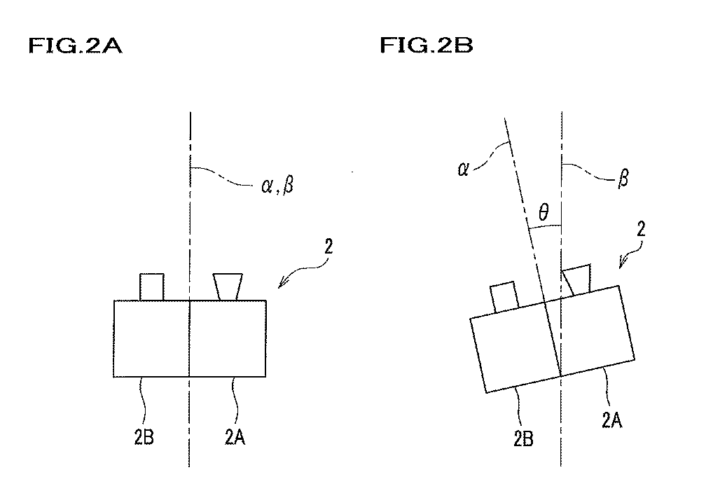

Referring to FIGS. 1 to 2B, an example of a sensing device 2 provided in a driving support device (external sensing device for a vehicle) 1 will be explained.

As illustrated in FIG. 1, in the sensing device 2, a millimeter wave radar 2A (FIG. 2) and an onboard camera 2B are accommodated in a casing 2C so as to have the same axis. The sensing device 2 is adjusted such that an irradiation direction of the millimeter wave radar 2A and an optical axis direction of the onboard camera 2B are coaxial. The same axis is referred as a sensing axis herein below. The sensing axis is adjusted to coincide with a traveling direction of a vehicle 90 and the sensing device 2 is attached near a rear view mirror 91 of the vehicle 90.

The millimeter wave radar 2A corresponds to an obstacle detection sensor according to claims.

Originally, as illustrated in FIG. 2A, the sensing device 2 is attached such that a sensing axis α coincides with the traveling direction β of the vehicle 90. However, as illustrated in FIG. 2B, the sensing axis α of the sensing device 2 may deviate from the traveling direction β of the vehicle 90. In this state, an obstacle position cannot be determined precisely and intended driving support control cannot be executed. Therefore, the driving support device 1 needs to correct a deviation angle θ between the sensing axis α and the traveling direction β of the vehicle 90.

As reasons for the deviation of the sensing axis α, variations in adjustment accuracy of the sensing axis α when the sensing device 2 is attached, axial deviation of the sensing axis α associated with a contact of an object on the sensing device 2, and an occurrence of a thrust angle of the vehicle 90 can be considered.

### Structure of the Driving Support Device

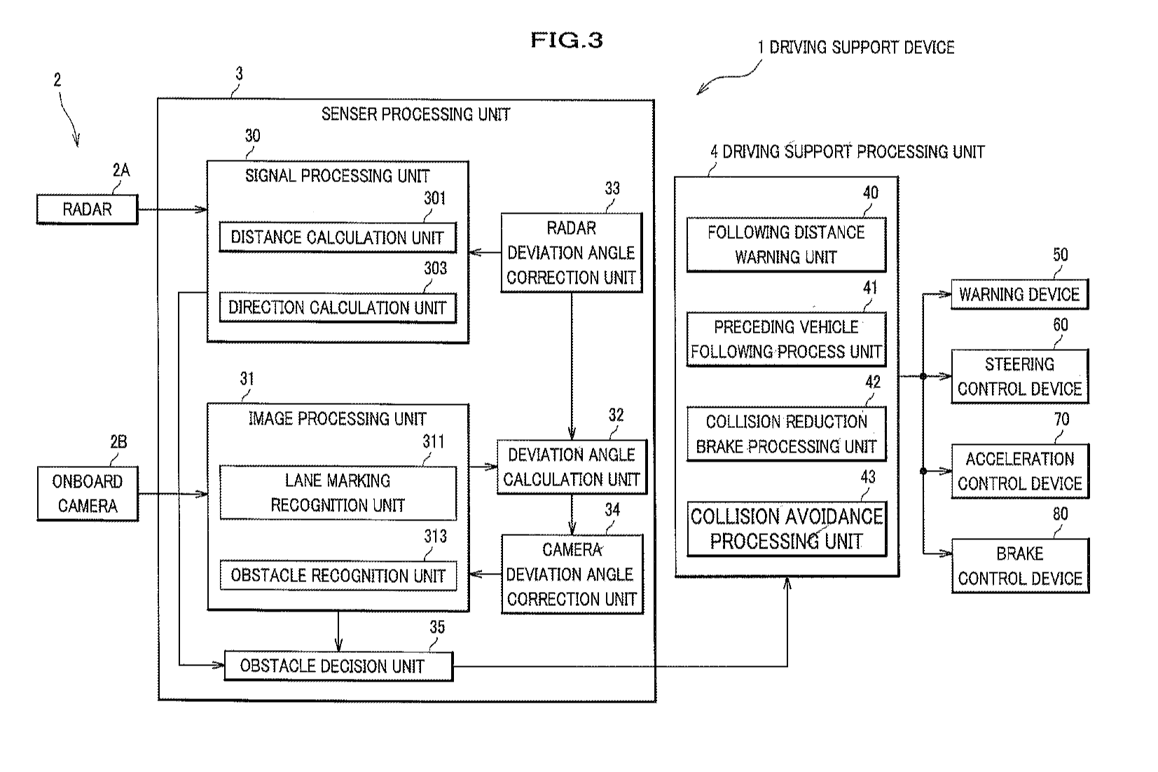

A structure of the driving support device 1 will be explained with reference to FIG. 3.

The driving support device 1 is mounted in the vehicle 90 (FIG. 1) and executes a driving support process such as cruise control of the vehicle 90 and warning to a driver. The driving support device 1 has the sensing device 2 (the millimeter wave radar 2A and the onboard camera 2B), a sensor processing unit 3 and a driving support processing unit 4.

In FIG. 3, the millimeter wave radar 2A is illustrated as a “radar 2A”.

Further, in FIG. 3, a warning device 50, a steering control device 60, an acceleration control device 70 and a brake control device 80 are illustrated as structure elements of the vehicle 90 related to the driving support device 1.

The millimeter wave radar 2A has a transmitting antenna from which a millimeter wave radar is irradiated to an obstacle as a transmitting wave and a receiving antenna which receives the millimeter wave reflected on the obstacle as a receiving wave (not illustrated). Further, the millimeter wave radar 2A generates a beat signal by mixing the transmitting wave and the receiving wave to output the beat signal to a signal processing unit 30.

Since the millimeter radar 2A is disclosed, for example, in JP2012-26791A (incorporated in the invention by the citation), detailed explanation will be omitted.

The onboard camera 2B is a CCD (Charge Coupled Device) camera or a CMOS (Complementary Metal Oxide Semiconductor) camera which can take images in a visible light region or an infrared region. The onboard camera 2B outputs the taken image in the traveling direction (a front direction) of the vehicle 90 to an image processing unit 31.

The sensor processing unit 3 determines the obstacle position based on various signals from the sensing device 2, calculates the deviation angle θ between the sensing axis α and the traveling direction β of the vehicle 90, and corrects the obstacle position by the determined deviation angle θ. The sensor processing unit 3 has the signal processing unit 30, the image processing unit 31, a deviation angle calculation unit 32, a radar deviation angle correction unit 33, a camera deviation angle correction unit 34 and an obstacle decision unit 35.

The signal processing unit 30 detects the obstacle position (distance and direction) based on the beat signal input from the millimeter wave radar 2A. The signal processing unit 30 has a distance calculation unit 301 and a direction calculation unit 303.

The distance calculation unit 301 calculates a distance from the vehicle 90 to the obstacle. For example, the distance calculation unit 301 analyses a frequency of the beat signal by FFT (Fast Fourier Transform) and detects a peak on a frequency axis. When a relative speed difference between the vehicle 90 and the obstacle exists, a frequency of the receiving wave shifts due to the Doppler effect. Therefore, the distance calculation unit 301 can calculate the obstacle position.

The direction calculation unit 303 calculates an obstacle direction to the vehicle 90. In case that the obstacle positions in front of the vehicle 90, phases of respective beat frequencies match, and thereby a transition frequency among beat signals becomes zero. On the other hand, in case that the obstacle positions obliquely with respect to the vehicle 90, a phase difference based on a path difference from the transmitting antenna to the receiving antenna is generated and a transition frequency corresponding to the phase difference appears among the beat signals. Therefore, the direction calculation unit 303 measures the transition frequency and can determine the obstacle direction based on the transition frequency.

The direction calculation unit 303 may be input with a correction command signal which indicates to correct the obstacle position by the deviation angle θ from the radar deviation angle correction unit 33 described later. In this case, the direction calculation unit 303 corrects the obstacle direction according to the deviation angle θ indicated by the correction command signal. For example, the direction calculation unit 303 refers to a direction correction amount table in which the deviation angle θ is associated with a direction correction amount of the obstacle, and corrects the obstacle direction by the direction correction amount according to the deviation angle θ.

The direction correction amount table is set, for example, manually or automatically in a production line.

The signal processing unit 30 generates obstacle data which indicates the obstacle position and outputs the obstacle data to the obstacle decision unit 35.

The image processing unit 31 recognizes lane markings and the obstacle position based on the taken image input from the onboard camera 2B. The image processing unit 31 has a lane marking recognition unit 311 and an obstacle recognition unit 313.

The lane marking recognition unit 311 recognizes two lane markings painted on a road in the taken image. For example, the lane marking recognition unit 311 executes a pattern matching with a vanishing point direction pattern and an edge as a lane marking recognition process and determines positions of the lane markings based on the taken image.

Since the lane marking recognition process is disclosed in JP2012-89005A (incorporated in the invention by the citation), explanation thereof will be omitted.

The obstacle recognition unit 313 recognizes the obstacle position in the traveling direction of the vehicle 90 based on the taken image. For example, the obstacle recognition unit 313 executes an obstacle recognition process such as an edge region extraction process and a color region extraction process on the taken image and determines the obstacle position (a coordinate) of the obstacle in the taken image.

When the correction command signal is input from the camera deviation angle correction unit 34 described later, the obstacle recognition unit 313 corrects the obstacle position according to the deviation angle θ indicated by the correction command signal. For example, the obstacle recognition unit 313 refers to a coordinate correction amount table in which the deviation angle θ is associated with a coordinate correction amount in the taken image and corrects the obstacle position by a coordinate change amount according to the deviation angle θ.

The coordinate correction amount table is, for example, set manually or automatically in the production line.

Further, the obstacle recognition unit 313 calculates a distance from the vehicle 90 to the obstacle by applying the motion stereo method to two taken images taken at different times.

Since the motion stereo method is disclosed, for example, in JP2012-52884A (incorporated in the invention by the citation), detailed explanation thereof will be omitted.

The image processing unit 31 generates image processing data indicating a position and a distance of the obstacle in the taken image and positions of lane markings, and outputs the image processing data to the obstacle decision unit 35. Farther, the image processing unit 31 outputs the image processing data and the taken image to the deviation angle calculation unit 32.

The deviation angle calculation unit 32 calculates a positional deviation amount between the vanishing point and a center of the taken image. The vanishing point is determined from at least the two lane markings included in the image processing data. The taken image is input from the image processing unit 31. Further, the deviation angle calculation unit 32 calculates the deviation angle θ based on the positional deviation amount.

The deviation angle calculation unit 32 decides whether the vehicle 90 is moving straight based on a lane marking shape, a steering angle or an angular velocity of the vehicle 90.

For example, the deviation angle calculation unit 32 executes a first approximation process on lane markings included in the taken image and determines whether the lane marking shape is straight. In case that the lane marking shape is determined as straight, the deviation angle calculation unit 32 decides that the vehicle 90 is moving straight. On the other hand, in case that the lane marking shape is not determined as straight, the deviation angle calculation unit 32 decides that the vehicle 90 is not moving straight.

The deviation angle calculation unit 32 may obtain the steering angle from the steering control device 60 to determine whether the vehicle 90 is moving straight.

Further, the deviation angle calculation unit 32 may obtain the angular velocity of the vehicle 90 from an angular velocity sensor (not illustrated) provided in the vehicle 90 to determine whether the vehicle 90 is moving straight.

Next, the deviation angle calculation unit 32 decides whether the lane marking recognition unit 311 can recognize at least the two lane markings from the taken image. Shortly, the deviation angle calculation unit 32 determines whether at least two valid lane markings are included in the image processing data.

In case that the vehicle is moving straight and at least the two lane markings can be recognized, the deviation angle calculation unit 32 preferably calculates the deviation angle θ and outputs the deviation angle θ to the radar deviation angle correction unit 33 and the camera deviation angle correction unit 34. While, in case that the vehicle is not moving straight or at least the two lane markings cannot be recognized, the deviation angle calculation unit 32 preferably does not calculate the deviation angle θ. Thus, a situation can be avoided, in which the obstacle position is corrected by the deviation angle calculation unit 32 even when the deviation angle θ is not calculated precisely.

### Specific Example of the Deviation Angle Calculation Process

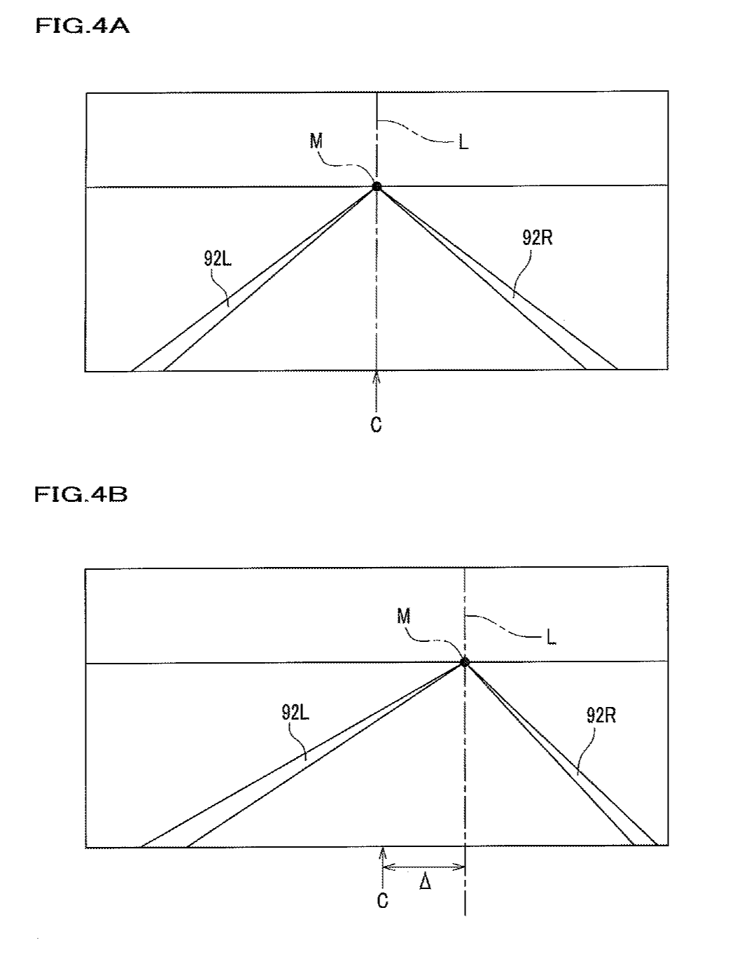

Referring to FIGS. 4A and 4B, a specific example of the deviation angle calculation process by the deviation angle calculation unit 32 will be explained (see FIGS. 2A to 3 as needed).

The specific example illustrates a process in which the deviation angle is calculated based on the vanishing point determined from two lane markings 92R, 92L. As illustrated in FIGS. 4A and 4B, the deviation angle calculation unit 32 determines an intersection to which the two lane markings 92R, 92L extend respectively as the vanishing point M. Further, the deviation angle calculation unit 32 determines an intermediate line L which passes the vanishing point M and is parallel with a vertical axis of the taken image. Then, the deviation angle calculation unit 32 determines the positional deviation amount Δ (not illustrated in FIG. 4A) between an intermediate coordinate C on a horizontal axis of the taken image and an intermediate line L.

In case that the sensing axis α and the traveling direction β of the vehicle 90 coincide as illustrated in FIG. 2A, the intermediate coordinate C and the intermediate line L coincide as illustrated in FIG. 4A. Therefore, the positional deviation amount Δ becomes zero. On the other hand, in case that the sensing axis α deviates from the traveling direction β of the vehicle 90 as illustrated in FIG. 2B, the intermediate coordinate C and the intermediate line L do not coincide as illustrated in FIG. 4B. The greater the deviation angle θ becomes, the greater the positional deviation amount Δ becomes.

Accordingly, the deviation angle calculation unit 32 calculates the deviation angle θ from the positional deviation amount Δ. For example, the deviation angle calculation unit 32 refers to a deviation angle conversion table in which the positional deviation amount Δ is associated with the deviation angle θ, and converts the positional deviation amount Δ to the deviation angle θ.

The deviation angle conversion table is set, for example, manually or automatically in the production line in consideration of a view angle of the onboard camera 2B.

Returning to FIG. 3, the structure of the driving support device 1 will be explained continuously.

The radar deviation angle correction unit 33 makes the signal processing unit 30 correct the obstacle position by the deviation angle θ input from the deviation angle calculation unit 32. Shortly, the radar deviation angle correction unit 33 generates a correction command signal including the deviation angle θ to output the correction command signal to the signal processing unit 30.

At this time, the radar deviation angle correction unit 33 preferably decides whether the deviation angle θ is equal to or more than a predetermined threshold value Th. In case that the deviation angle θ is equal to or more than the threshold value Th, the radar deviation angle correction unit 33 outputs the correction command signal to the signal processing unit 30. On the other hand, in case that the deviation angle θ is less than the threshold value Th, the radar deviation angle correction unit 33 does not output the correction command signal to the signal processing unit 30. Thus, the radar deviation angle correction unit 33 does not make the signal processing unit 30 correct the obstacle position in case of little influence of the axis deviation, and thereby hunting of the obstacle position can be prevented.

The threshold value Th is set manually or automatically in the production line.

The camera deviation angle correction unit 34 makes the image processing unit 31 correct the obstacle position by the deviation angle θ input from the deviation angle calculation unit 32. Shortly, the camera deviation angle correction unit 34 generates the correction command signal including the deviation angle θ and outputs the correction command signal to the image processing unit 31.

At this time, the camera deviation angle correction unit 34 preferably decides whether the deviation angle θ is equal to or more than the threshold value Th. In case that the deviation angle θ is equal to or more than the threshold value Th, the camera deviation angle correction unit 34 outputs the correction command signal to the image processing unit 31. On the other hand, in case that the deviation angle θ is less than the threshold value Th, the camera deviation angle correction unit 34 does not output the correction command signal to the image processing unit 31. Thus, the camera deviation angle correction unit 34 does not make the image processing unit 31 correct the obstacle position in case of little influence of the axis deviation, and thereby the hunting of the obstacle position can be prevented.

The radar deviation angle correction unit 33 and the camera deviation angle correction unit 34 correspond to a deviation angle correction unit in claims.

Further, since the radar deviation angle correction unit 33 and the camera deviation angle correction unit 34 use the same threshold value Th, decision results whether the deviation angle θ is equal to or more than the threshold value Th become the same.

The obstacle decision unit 35 integrates the obstacle data input from the signal processing unit 30 with the image processing data input from the image processing unit 31. Further, the obstacle decision unit 35 decides whether the obstacle recognized by the onboard camera 2B and the obstacle detected by the radar 2A are the same.

In case that a distance between the obstacles included in the image processing data and the obstacle data is less than a predetermined distance threshold value, the obstacle decision unit 35 decides that both the obstacles are the same. On the other hand, in case that a distance between the obstacles included in the image processing data and the obstacle data is equal to or more than the predetermined distance threshold value, the obstacle decision unit 35 decides that both the obstacles are different. Then, the obstacle decision unit 35 generates obstacle position information which indicates each obstacle position.

The obstacle decision unit 35 outputs the generated obstacle position information to the driving support processing unit 4.

The driving support processing unit 4 executes the driving support process based on the obstacle position information input from the obstacle decision unit 35. The driving support processing unit 4 has a following distance warning unit 40, a preceding vehicle following process unit 41, a collision reduction brake processing unit 42 and a collision avoidance processing unit 43.

When a following distance between the vehicle 90 and a preceding vehicle (obstacle) is short, the following distance warning unit 40 warns to a driver. For example, in case that the following distance between the vehicle 90 and the preceding vehicle is short, the following distance warning unit 40 commands the warning device 50 to warn the driver.

The preceding vehicle following process unit 41 makes the vehicle 90 follow a preceding vehicle. For example, the preceding vehicle following process unit 41 commands the steering control device 60, the acceleration control device 70 and the brake control device 80 that the vehicle 90 follows the preceding vehicle having a proper following distance.

The collision reduction brake processing unit 42 reduces impact when the vehicle 90 collides with an obstacle. For example, in case that there is a possibility for the vehicle 90 to collide with the obstacle, the collision reduction brake processing unit 42 commands the brake control device 80 to slow down the vehicle 90.

The collision avoidance processing unit 43 avoids collision with the obstacle. For example, in case that there is a possibility for the vehicle 90 to collide with the obstacle, the collision avoidance processing unit 43 commands the steering control device 60 such that the vehicle 90 is steered to avoid the obstacle.

It is needless to say that, in addition to the obstacle position information, the driving support processing unit 4 can use driving condition information which indicates a driving condition of the vehicle 90 when the driving support process is executed. For example, the driving support processing unit 4 obtains detection results from a speed sensor, a raindrop sensor (weather sensor) and an inclination sensor (not illustrated) as the driving condition information and uses the detection results for cruise control of the vehicle 90 and a warning to the driver. Further, for example, the driving support processing unit 4 obtains road condition information which indicates a road condition as the driving condition information by road-to-vehicle communication and uses the road condition information for the driving support process.

The warning device 50 warns the driver based on a command input from the driving support processing unit 4. For example, the warning device 50 executes the following warnings (A) to (D) in predetermined combinations and makes the driver recognize a possibility of the collision.
(A) Tightening a seat belt with predetermined tension
(B) Vibrating a steering wheel
(C) Blinking a warning lamp
(D) Outputting a warning sound to a speaker

The steering control device 60 controls a steering actuator (not illustrated) based on the command input from the driving support processing unit 4. For example, the steering control device 60 controls a steering operation of the steering actuator such that the vehicle 90 follows the preceding vehicle or the vehicle 90 avoids the obstacle.

The acceleration control device 70 controls an accelerator (not illustrated) based on the command input from the driving support processing unit 4. For example, the acceleration control device 70 controls an opening/closing of the accelerator (throttle) such that the vehicle 90 follows the preceding vehicle.

The brake control device 80 controls a brake actuator (not illustrated) based on the command input from the driving support processing unit 4. For example, in case that there is a possibility that the vehicle 90 collides with the obstacle, the brake control device 80 controls a deceleration operation of the brake actuator such that the vehicle 90 decelerates.

Since the driving support process is disclosed, for example, in JP2007-91208A (incorporated in the invention by the citation), detailed description thereof will be omitted.

### Operation of the Driving Support Device

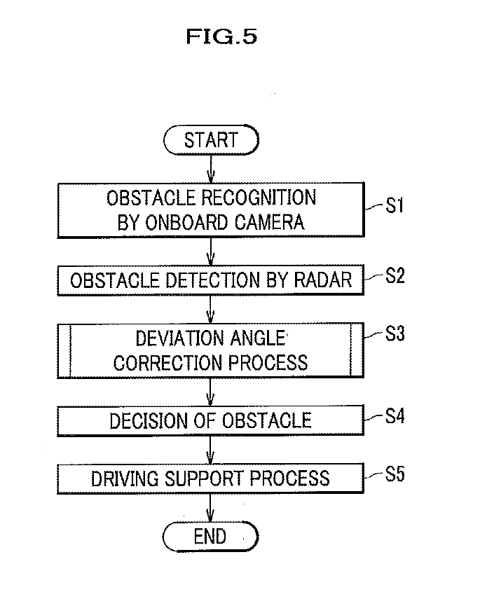

Referring to FIG. 5, an operation of the driving support device 1 will be explained (see FIG. 3 as needed).

The driving support device 1 generates the taken image of the traveling direction of the vehicle 90 taken by the onboard camera 2B. Then, the driving support device 1 recognizes the obstacle position in the traveling direction of the vehicle 90 based on the taken image by the obstacle recognition unit 313 (step S1).

The driving support device 1 irradiates millimeter wave radar (transmitting wave) to the obstacle by the millimeter wave radar 2A and receives the receiving wave of the millimeter wave radar reflected by the obstacle. The driving support device 1 generates the beat signal in which the transmitting wave and the receiving wave are mixed. The driving support device 1 detects the obstacle position based on the beat signal by the signal processing unit 30 (step S2).

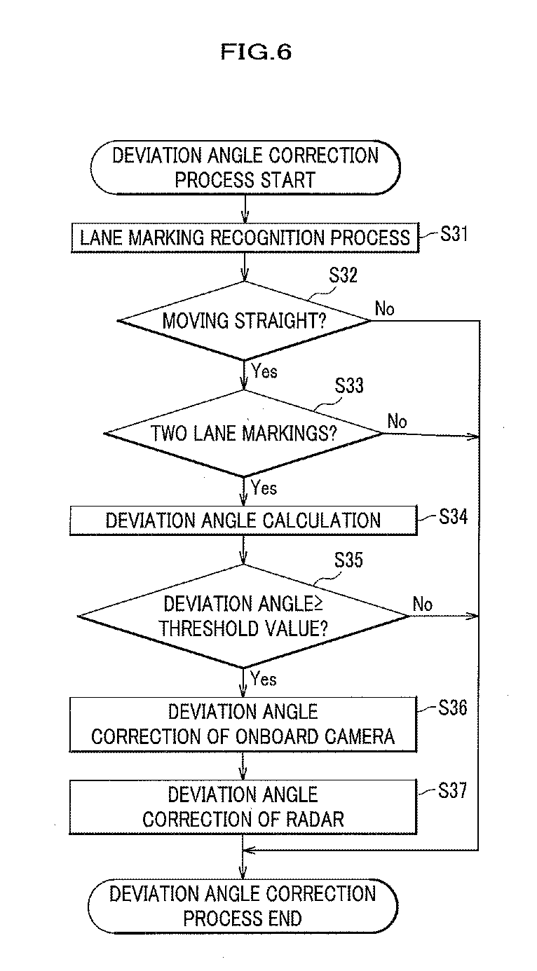

The driving support device 1 corrects the deviation angle θ between the sensing axis α and the traveling direction β of the vehicle 90 (step S3: deviation angle correction process). The deviation angle correction process will be described later in detail (see FIG. 6).

The driving support device 1 decides whether the obstacle recognized by the onboard camera 2B and the obstacle detected by the radar 2A are the same by the obstacle decision unit 35, and generates the obstacle position information (step S4).

The driving support device 1 executes the cruise control of the vehicle 90 and the warning to the driver based on the obstacle position information by the driving support processing unit 4 (step S5: driving support process).

### Deviation Angle Correction Process

Referring to FIG. 6, the deviation angle correction process illustrated in FIG. 5 will be explained (see FIG. 3 as needed).

The driving support device 1 recognizes at least the two lane markings painted on the road based on the taken image by the lane marking recognition unit 311 (step S31: lane marking recognition step).

The driving support device 1 decides whether the vehicle 90 is moving straight by the deviation angle calculation unit 32 (step S32).

In case that the vehicle 90 is moving straight (Yes in step S32), the driving support device 1 decides whether at least the two lane markings can be recognized in step S31 by the deviation angle calculation unit 32 (step S33).

In case that at least the two lane markings can be recognized (Yes in step S33), the driving support device 1 calculates the deviation angle θ using the method of the specific example described above by the deviation angle calculation unit 32 (step S34: deviation angle calculation step).

The driving support device 1 decide whether the deviation angle θ is equal to or more than the threshold value Th by the radar deviation angle correction unit 33 and the camera deviation angle correction unit 34 (step S35).

In case that the deviation angle θ is equal to or more than the threshold value Th (Yes in step S35), the driving support device 1 executes a process of step S36. In this case, the driving support device 1 does not correct the deviation angle θ and executes the driving support process.

The driving support device 1 generates the correction command signal by the camera deviation angle correction unit 34. Then, the driving support device 1 corrects the obstacle position according to the deviation angle θ indicated by the correction command signal by the obstacle recognition unit 313 (step S36).

The driving support device 1 generates the correction command signal by the radar deviation angle correction unit 33. Then, the driving support device 1 corrects the obstacle direction according to the deviation angle θ indicated by the correction command signal by the direction calculation unit 303 (step S37).

The steps S36 and S37 correspond to a deviation angle correction step described in claims.

The driving support device 1 terminates the deviation angle correction process when the vehicle 90 is not moving straight (No in step S32), when at least the two lane markings cannot be recognized (No in step S33), when the deviation angle θ is not equal to or more than the threshold value Th (No in step S35), or when the process in step S37 is done.

### Effect/Advantage

As described above, since at least the two lane markings recognized based on the taken image do not suffer lateral deviation, the driving support device 1 can calculate the deviation angle correctly and can correct the axis deviation precisely. Thus, the driving support device 1 can reduce a burden for an adjusting operation and can realize a proper driving support process.

According to the inventions, the following excellent effects can be acquired.

According to the first, the seventh and the eighth inventions, since at least the two lane markings recognized based on the taken image do not suffer the lateral deviation, the deviation angle can be calculated correctly and the axis deviation can be corrected precisely. With the effect, the first, the seventh and the eighth inventions can reduce a burden for an adjusting operation of the external sensing device for a vehicle and can contribute to realize a proper driving support process.

In the second invention, since the axial directions of the onboard camera and the obstacle detection sensor have been adjusted, the external sensing device for a vehicle can be attached in the vehicle easily.

In the third invention, since the positional deviation amount is calculated precisely based on the vanishing point and the center in the taken image, the deviation angle can be calculated correctly.

In the fourth invention, since the obstacle position is not corrected when an effect of the axis deviation is less, a situation in which the obstacle position varies frequently can be prevented (hunting prevention). This leads to a contribution to realize a proper driving support process.

In the fifth invention, a situation in which the obstacle position is corrected even when the deviation angle is not calculated correctly is avoided. This leads to a contribution to realize a proper driving support process.

In the sixth invention, a driving support process based on a correct obstacle position can be executed.

### Modification

The invention is not limited to the embodiment described above and can cover various modifications without departing from the object of the invention. Specific modifications of the invention will be explained below.

In the embodiment, the sensing device 2 has the millimeter wave radar 2A and the onboard camera 2B, but the invention is not limited thereto.

The sensing device 2 may have a laser radar instead of the millimeter wave radar 2A.

Further, the sensing device 2 may have a second onboard camera (not illustrated) instead of the millimeter wave radar 2A. In this case, the driving support device 1 has a pair of onboard cameras (stereo camera) and recognizes the obstacle position based on the principle of triangulation.

The driving support device 1 can execute the deviation angle correction process at an arbitrary timing.

For example, the driving support device 1 can execute the deviation angle correction process at one of the timings (1) to (3) described below.
(1) When the sensing device 2 is attached in the vehicle 90 in the production line
(2) When the vehicle 90 is maintained in a maintenance shop
(3) When the driver commands

Especially, in case that the driving support device 1 executes the deviation angle correction process at the timing of (1), an adjustment operation for mating the sensing axis with the traveling direction of the vehicle 90 can be omitted when the sensing device 2 is attached in the vehicle 90. This contributes to a production process reduction.

In the embodiment described above, the driving support device 1 is explained as an independent hardware, but the invention is not limited thereto. For example, the driving support device 1 can be executed by an axis deviation correction program which makes hardware resources such as a CPU, a memory, a hard disk in a computer operate in cooperation as the sensor processing unit 3 and the driving support processing unit 4. The program may be distributed via a communication line or may be distributed as a recording medium such as a CD-ROM or a flash memory.

What is claimed is:

1. An external sensing device for a vehicle that corrects a deviation angle between an axial direction of an onboard camera and an obstacle detection sensor mounted in a vehicle to have a same axis and a traveling direction of the vehicle, comprising:
a lane marking recognition unit that recognizes at least two lane markings painted on a road based on a taken image in which the traveling direction of the vehicle is taken by the onboard camera;
a deviation angle calculation unit that decides whether the vehicle is moving straight, and calculates the deviation angle based on at least the two lane markings recognized by the lane marking recognition unit when the vehicle is moving straight; and
a deviation angle correction unit that corrects an obstacle position recognized based on the taken image and an obstacle position detected by the obstacle detection sensor by the deviation angle calculated by the deviation angle calculation unit.

2. The external sensing device for a vehicle according to claim 1, wherein the onboard camera and the obstacle detection sensor are accommodated in one casing and are adjusted so that an optical axis direction of the onboard camera and an irradiation direction of the obstacle detection sensor have a same axis.

3. The external sensing device for a vehicle according to claim 1, wherein the deviation angle calculation unit determines a positional deviation amount between a vanishing point that is determined based on at least the two lane markings recognized by the lane marking recognition unit and a center of the taken image, and calculates the deviation angle based on the positional deviation amount.

4. The external sensing device for a vehicle according to claim 2, wherein the deviation angle calculation unit determines a positional deviation amount between a vanishing point that is determined based on at least the two lane markings recognized by the lane marking recognition unit and a center of the taken image, and calculates the deviation angle based on the positional deviation amount.

5. The external sensing device for a vehicle according to claim 1, wherein the deviation angle correction unit decides whether the deviation angle calculated by the deviation angle calculation unit is equal to or more than a predetermined threshold value and corrects the obstacle position when the deviation angle is equal to or more than the threshold value.

6. The external sensing device for a vehicle according to claim 2, wherein the deviation angle correction unit decides whether the deviation angle calculated by the deviation angle calculation unit is equal to or more than a predetermined threshold value and corrects the obstacle position when the deviation angle is equal to or more than the threshold value.

7. The external sensing device for a vehicle according to claim 3, wherein the deviation angle correction unit decides whether the deviation angle calculated by the deviation angle calculation unit is equal to or more than a predetermined threshold value and corrects the obstacle position when the deviation angle is equal to or more than the threshold value.

8. The external sensing device for a vehicle according to claim 1, wherein the deviation angle calculation unit does not calculate the deviation angle in case that the lane marking recognition unit cannot recognize the lane markings or in case that the vehicle is not moving straight.

9. The external sensing device for a vehicle according to claim 2, wherein the deviation angle calculation unit does not calculate the deviation angle in case that the lane marking recognition unit cannot recognize the lane markings or is case that the vehicle is not moving straight.

10. The external sensing device for a vehicle according to claim 3, wherein the deviation angle calculation unit does not calculate the deviation angle in case that the lane marking recognition unit cannot recognize the lane markings or in case that the vehicle is not moving straight.

11. The external sensing device for a vehicle according to claim 4, wherein the deviation angle calculation unit does not calculate the deviation angle in case that the lane marking recognition unit cannot recognize the lane markings or is case that the vehicle is not moving straight.

12. The external sensing device for a vehicle according to claim 1 further comprising a driving support processing unit that executes a driving support process for the vehicle based on the obstacle position corrected by the deviation angle correction unit.

13. The external sensing device for a vehicle according to claim 2 further comprising a driving support processing unit that executes a driving support process for the vehicle based on the obstacle position corrected by the deviation angle correction unit.

14. The external sensing device for a vehicle according to claim 3 further comprising a driving support processing unit that executes a driving support process for the vehicle based on the obstacle position corrected by the deviation angle correction unit.

15. The external sensing device for a vehicle according to claim 4 further comprising a driving support processing unit that executes a driving support process for the vehicle based on the obstacle position corrected by the deviation angle correction unit.

16. The external sensing device for a vehicle according to claim 5 further comprising a driving support processing unit that executes a driving support process for the vehicle based on the obstacle position corrected by the deviation angle correction unit.

17. A non-transitory computer readable medium with an executable program stored thereon that makes a computer function as the external sensing device for a vehicle according to claim 1.

18. A method of correcting axis deviation of an external sensing device for a vehicle having a lane marking recognition unit, a deviation angle calculation unit and a deviation angle calculation unit that corrects a deviation angle between an axial direction of an onboard camera and an obstacle detection sensor mounted in a vehicle to have a same axis and a traveling direction of the vehicle, comprising steps of:
recognizing by the lane marking recognition unit at least two lane markings painted on a road based on a taken image in which the traveling direction of the vehicle is taken by the onboard camera;
deciding whether the vehicle is moving straight, and calculating the deviation angle by the deviation angle calculation unit based on at least the two lane markings recognized by the lane marking recognition unit when the vehicle is moving straight; and
correcting by the deviation angle correction unit an obstacle position recognized based on the taken image and an obstacle position detected by the obstacle detection sensor by the deviation angle calculated in the deviation angle calculation.
